(19) United States
(12) Patent Application Publication
(10) Pub. No.: US 2025/0085538 A1
(43) Pub. Date: Mar. 13, 2025

(54) HEAD-UP DISPLAY DEVICE

(71) Applicant: Coretronic Corporation, Hsin-Chu (TW)

(72) Inventors: Kuei-En Peng, Hsin-Chu (TW); Yi-Tien Lu, Hsin-Chu (TW); Po-Che Lee, Hsin-Chu (TW)

(73) Assignee: Coretronic Corporation, Hsin-Chu (TW)

(21) Appl. No.: 18/818,499

(22) Filed: Aug. 28, 2024

(30) Foreign Application Priority Data
Sep. 13, 2023 (TW) 112134772

(51) Int. Cl. G02B 27/01

(52) U.S. Cl. CPC G02B 27/0101

(57) ABSTRACT

A head-up display (HUD) device includes a display element, a first reflective element, and a second reflective element. The display element provides an image light beam that includes a first light beam and a second light beam, where the first light beam and the second light beam exit from different positions of the display element. The first reflective element is disposed on a transmission path of the image light beam coming from the display element to reflect the image light beam. The second reflective element is disposed on a transmission path of the image light beam coming from the first reflective element to reflect the image light beam. A primary ray of the first light beam and a primary ray of the second light beam exiting from the display element form an intersection point on the first reflective element or between the display element and the first reflective element.

### CROSS-REFERENCE TO RELATED APPLICATION

This application claims the priority benefit of Taiwan application serial no. 112134772, filed on Sep. 13, 2023. The entirety of the above-mentioned patent application is hereby incorporated by reference herein and made a part of this specification.

### BACKGROUND

### 1. Technical Field

The disclosure relates to a display device and particularly relates to a head-up display (HUD) device.

### 2. Description of Related Art

In contemporary society, the focus on transportation vehicle performance has been joined by an increasing emphasis on interior design and safety features. Current technological innovations, such as in-car voice navigation systems and voice collision warning systems, have significantly contributed to reducing accidents stemming from factors like fatigue or lack of concentration during long drives. Nevertheless, a common drawback is the presence of non-voice information display devices mounted on the dashboard, which may easily distract drivers when they look down and potentially compromises safety.

The utilization of a head-up display (HUD), which projects essential information directly in the driver's line of sight and allows the driver to stay focused on the road without the need to divert his gaze or turn his head. By incorporating a HUD device into a vehicle, various screens displaying different traffic information or assisting with driving functions may be positioned on the windshield to ensure the driver can access pertinent data without shifting his attention away from the road. However, the existing HUD devices often suffer from bulkiness, primarily due to the increased size and quantity of internal components. Such bulkiness may lead to interference problems with other components within the body of the vehicle.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

One or more embodiments of the disclosure provide a head-up display (HUD) device which utilizes fewer optical elements and may still shorten the length of a light path and have a reduced volume.

Other objectives and advantages of the disclosure may be further understood from the technical features disclosed in the disclosure.

In order to achieve one, some, or all of the aforementioned objectives or other objectives, an embodiment of the disclosure provides a HUD device including a display element, a first reflective element, and a second reflective element is provided. The display element provides an image light beam that includes a first light beam and a second light beam, where the first light beam and the second light beam exit from different positions of the display element. The first reflective element is disposed on a transmission path of the image light beam coming from the display element and configured to reflect the image light beam. The second reflective element is disposed on a transmission path of the image light beam coming from the first reflective element and configured to reflect the image light beam, where a primary ray of the first light beam and a primary ray of the second light beam exiting from the display element form an intersection point on the first reflective element or between the display element and the first reflective element.

Based on the above, at least one of the following advantages or effects is present in one or more embodiments of the disclosure. The HUD device provided in one or more embodiments of the disclosure includes the display element, the first reflective element, and the second reflective element. The display element provides the image light beam to the first reflective element, the first reflective element reflects the image light beam to the second reflective element, and the second reflective element reflects the image light beam and generates an image through the imaging element. Here, the image light beam includes the first light beam and the second light beam, and the primary ray of the first light beam and the primary ray of the second light beam that exit from the display element form the intersection point on the first reflective element or between the display element and the first reflective element. As such, compared with conventional HUDs, the HUD device provided herein is designed to utilize fewer optical elements, and the size of the first reflective element may be designed as the smallest size, thereby shortening the length of the light path of the HUD device and reducing the volume of the HUD device.

Other objectives, features and advantages of the disclosure will be further understood from the further technological features disclosed by the embodiments of the present disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic view of a HUD device according to an embodiment of the disclosure.

FIG. 2 is a diagram illustrating a comparison between an overall light spot size on the first reflective element of the HUD device depicted in FIG. 1 and an overall light spot size provided in the related art.

FIG. 3 is a diagram illustrating a comparison between a part of a light spot size on the first reflective element of the HUD device depicted in FIG. 1 and a part of a light spot size provided in the related art.

### DESCRIPTION OF THE EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as “top,” “bottom,” “front,” “back,” etc., is used with reference to the orientation of the Figure(s) being described. The components of the disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

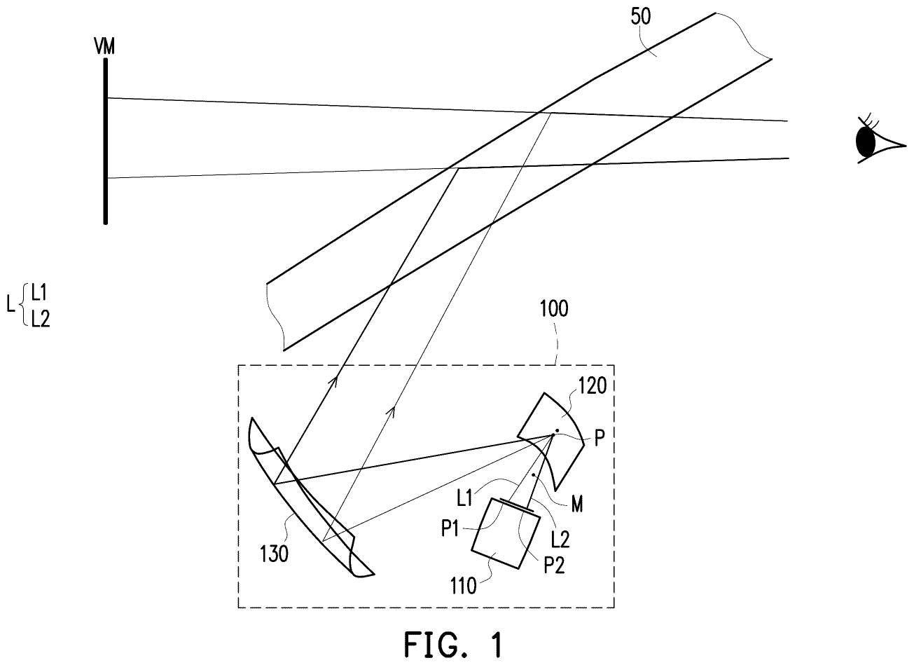

FIG. 1 is a schematic view of a HUD device according to an embodiment of the disclosure. With reference to FIG. 1, a HUD device 100 including a display element 110, a first reflective element 120, and a second reflective element 130 is provided in the present embodiment. The display element 110 provides an image light beam L, which is transmitted to the outside of the HUD device 100 through the first reflective element 120 and the second reflective element 130. The HUD device 100 is, for instance, a vehicle HUD, which reflects the image light beam L from the HUD device 100 to a viewer's (such as a transportation driver) eyes through an imaging element 50, thus allowing the viewer to see a virtual image VM with driving information in front of the imaging element 50. The display element 110 is, for instance, a picture generation unit (PGU), which should however not be construed as a limitation to this disclosure. The imaging element may be a windshield, a see-through combiner, and so on.

The image light beam L includes a first beam and a second beam, the first beam has a primary ray L1, and the second beam has a primary ray L2. In FIG. 1, the primary ray L1 of the first beam and the primary ray L2 of the second beam are shown as examples. Specifically, the first beam and the second beam carry different image information and exit from different positions P1 and P2 of the display element 110, respectively. For instance, in the present embodiment, an effective display region of the display element 110 has a first display region and a second display region, the first beam exits from the first display region, and the second beam exits from the second display region. However, the present embodiment does not limit an area ratio of the two different display regions on the display element 110. In the present embodiment, on the display element 110, a first position P1 where the first beam exits from is closer to the second reflective element 130 than the position P2 where the second beam exits from, which should however not be construed as a limitation to the disclosure.

The first reflective element 120 is disposed on a transmission path of the image light beam L coming from the display element 110 and configured to reflect the image light beam L. The second reflective element 130 is disposed on a transmission path of the image light beam L coming from the first reflective element 120 and configured to reflect the image light beam L to the imaging element 50 outside the HUD device 100. Specifically, in the present embodiment, the first reflective element 120 and the second reflective element 130 are curved reflective mirrors, and reflective surfaces of the first reflective element 120 and the second reflective element 130 are both freeform surfaces. Moreover, in the HUD device 100 provided in the present embodiment, the first reflective element 120 and the second reflective element 130 are disposed; that is, only these two reflective optical elements are disposed in the HUD device 100, and no other reflective optical element is disposed. On the other hand, in the present embodiment, no other optical element is disposed on a light path of the image light beam between the display element 110 and the first reflective element 120. Therefore, compared with the conventional HUD, the HUD device provided in the present embodiment is designed to have fewer optical elements, so as to ensure the HUD device has the reduced volume.

It is worth mentioning that the present embodiment provides a secondary imaging optical system. On the light path of the image light beam L traveling from the display element 110 to the imaging element 50, an intermediate image is formed between the first reflective element 120 and the second reflective element 130. The advantage of the secondary imaging optical system structure lies in that the length of the light path is reduced, and so is the volume. To be specific, the first and second light beams exiting from different positions P1 and P2 of the display element 110 provided herein are not transmitted in parallel; that is, the image light beam L provided by the display element 110 is gradually converged during the transmission process towards the first reflective element 120, and the image light beam L exiting from the display element 110 is a convergent light beam. More specifically, the primary rays L1 and L2 of the first and second light beams exiting from the display element 110 form an intersection point P on the first reflective element 120 or between the display element 110 and the first reflective element 120. For instance, in the embodiment depicted FIG. 1, the intersection point P is located on the first reflective element 120, and thus the intersection point P of the primary rays L1 and L2 of the first and second light beams is located on the smallest light spot formed by the image light beam L. Here, the smallest light spot refers to the smallest cross-sectional area of the image light beam L on the transmission path within the HUD device 100. However, in different embodiments, the light path between the display element 110 and the first reflective element 120 of the image light beam L has a middle point M. When the intersection point P is located between the display element 110 and the first reflective element 120, the intersection point P is located between the middle point M and the first reflective element 120. That is, the intersection point P is located closer to the first reflective element 120.

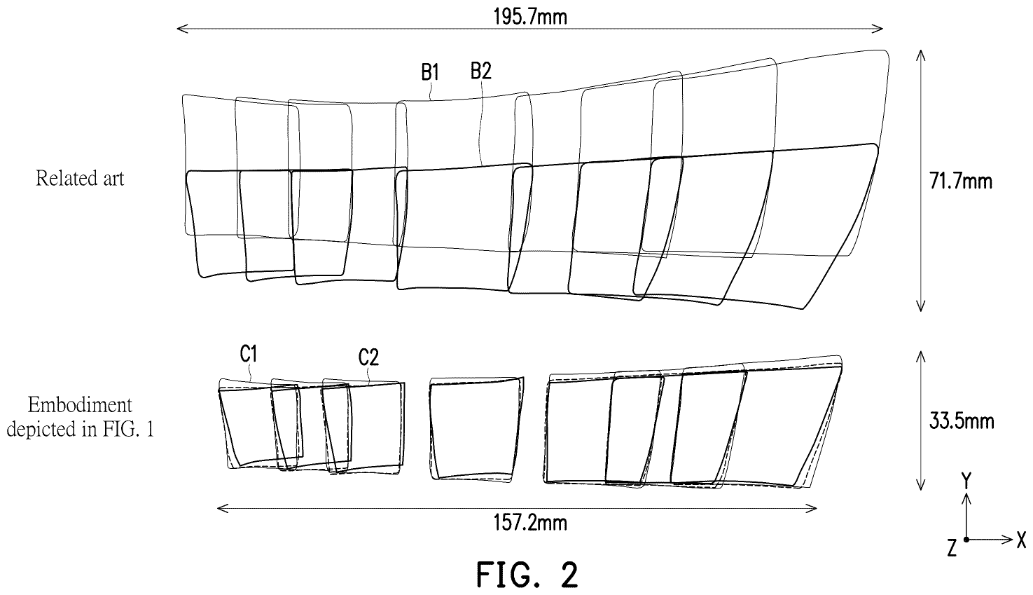

FIG. 2 is a diagram illustrating a comparison between an overall light spot size on the first reflective element of the HUD device depicted in FIG. 1 and an overall light spot size provided in the related art. It should be noted that since the first reflective element 120 is not a planar reflective element, an XY plane constituted by an X axis and a Y axis shown in FIG. 2 is a reference plane schematically disposed on the first reflective element 120 for forming a light spot, and a normal line of the reference plane is a Z axis. Please refer to FIG. 1 and FIG. 2. FIG. 1, for instance, illustrates an embodiment where the intersection point P is located on the first reflective element 120, the first light beam forms the first light spot C1 on the first reflective element 120, and the second light beam forms the second light spot C2 on the first reflective element 120. Compared with the related art, in the present embodiment, by designing the intersection point P of the primary ray L1 of the first light beam and the primary ray L2 of the second light beam to be located on the first reflective element 120 or between the display element 110 and the first reflective element 120, the length of the light path may be effectively shortened, and the area occupied by the first reflective element 120 may be reduced, thereby reducing the volume of the HUD device 100. For instance, from the position distribution of the different light spots B1 and B2 formed on the reflective element in the HUD provided in the related as shown in FIG. 2 and the position distribution of the first light spot C1 and the second light spot C2 formed on the first reflective element 120 in the HUD device 100 provided in the embodiment in FIG. 1, it may be observed that an overlapping relationship between the light spots formed by all the light beams in the image light beam L allows the overall light spot formed by the image light beam L provided herein to be shortened from 195.7 mm to 157.2 mm in the X axis; that is, the overall light spot length of the HUD device 100 provided herein is reduced by 20% in comparison with the HUD provided in the related art, and in the Y axis, the overall light spot formed by the image light beam L is shortened from 71.7 mm to 33.52 mm; that is, the overall light spot height of the HUD device 100 provided herein is reduced by 53% c in comparison with the HUD provided in the related art. Accordingly, as compared to the conventional HUD, the HUD device 100 in the present embodiment may ensure that the length and the height of the overall light spot formed by the image light beam L on the first reflective element 120, thereby reducing the size of the first reflective element 120 and reducing the volume of the HUD device 100.

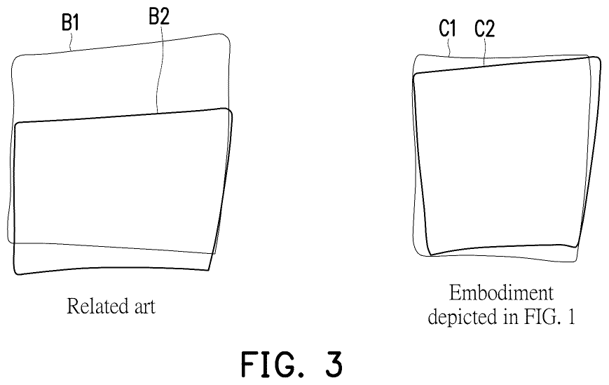

FIG. 3 is a diagram illustrating a comparison between a part of a light spot size on the first reflective element of the HUD device depicted in FIG. 1 and a part of a light spot size provided in the related art. With reference to FIG. 1 and FIG. 3, in the present embodiment, for instance, an overlapping area of the first light spot C1 corresponding to the first light beam and the second light spot C2 corresponding to the second light beam on the first reflective element 120 is at least greater than 90%. As such, the size of the first reflective element 120 may be designed to be the smallest size, thereby reducing the volume of the HUD device 100.

To sum up, the HUD device provided in one or more embodiments of the disclosure includes the display element, the first reflective element, and the second reflective element. The display element provides the image light beam to the first reflective element, the first reflective element reflects the image light beam to the second reflective element, and the second reflective element reflects the image light beam and generates an image through the imaging element. Here, the image light beam includes the first light beam and the second light beam, and the primary ray of the first light beam and the primary ray of the second light beam that exit from the display element form the intersection point on the first reflective element or between the display element and the first reflective element. As such, compared with the conventional HUD, the HUD device provided herein is designed to utilize fewer optical elements, and the size of the first reflective element may be designed as the smallest size, thereby shortening the length of the light path of the HUD device and reducing the volume of the HUD device.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure” does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the disclosure as defined by the following claims. Moreover, no element and component in the present disclosure is intended to be dedicated to the public regardless of whether the element or component is explicitly recited in the following claims.

What is claimed is:

1. A head-up display device, comprising:
a display element, providing an image light beam, the image light beam comprising a first light beam and a second light beam, wherein the first light beam and the second light beam exit from different positions of the display element;
a first reflective element, disposed on a transmission path of the image light beam coming from the display element and configured to reflect the image light beam; and
a second reflective element, disposed on a transmission path of the image light beam coming from the first reflective element and configured to reflect the image light beam, wherein a primary ray of the first light beam and a primary ray of the second light beam exiting from the display element form an intersection point on the first reflective element or between the display element and the first reflective element.

2. The head-up display device as claimed in claim 1, wherein the intersection point of the primary ray of the first light beam and the primary ray of the second light beam is located on a smallest light spot formed by the image light beam.

3. The head-up display device as claimed in claim 1, wherein the image light beam has a middle point in a light path between the display element and the first reflective element, and when the intersection point is located between the display element and the first reflective element, the intersection point is located between the middle point and the first reflective element.

4. The head-up display device as claimed in claim 1, wherein the image light beam exiting from the head-up display device is transmitted to an imaging element, and a virtual image is formed through the imaging element.

5. The head-up display device as claimed in claim 1, wherein reflective surfaces of the first reflective element and the second reflective element are freeform surfaces.

6. The head-up display device as claimed in claim 1, wherein the head-up display device comprises only the first reflective element and the second reflective element as two reflective optical elements.

7. The head-up display device as claimed in claim 1, wherein the image light beam provided by the display element is a convergent light beam between the display element and the first reflective element.

8. The head-up display device as claimed in claim 1, wherein no optical element is disposed between the display element and the first reflective element.

9. The head-up display device as claimed in claim 1, wherein the first light beam and the second light beam exiting from the display element are not parallel to each other.

10. The head-up display device as claimed in claim 1, wherein compared to the second light beam, the first light beam exits from a closer position on the display element to the second reflective element.

11. The head-up display device as claimed in claim 1, wherein the first light beam forms a first light spot on the first reflective element, the second light beam forms a second light spot on the first reflective element, and an overlapping area of the first light spot and the second light spot on the first reflective element is at least greater than 90%.
